(19) United States
(12) Patent Application Publication
(10) Pub. No.: US 2026/0236543 A1
(43) Pub. Date: Aug. 13, 2026

(54) SYSTEMS AND METHODS FOR REPORTING METRICS LEVERAGING LARGE LANGUAGE MODEL AND ARTIFICIAL INTELLIGENCE CHATBOT SERVICE

(71) Applicant: OPEN TEXT HOLDINGS, INC., Menlo Park, CA (US)

(72) Inventors: RaviTeja Panchangam, Hyderabad (IN); Anindita Dutta, Hyderabad (IN); Sangeetha Yanamandra, Hyderabad (IN); Jeevi Reddy Gudibandi, Hyderabad (IN); Ravi Kiran Rimmanapudi, Hyderabad (IN); Pradeep Neerukonda, Hyderabad (IN)

(21) Appl. No.: 19/048,791

(22) Filed: Feb. 7, 2025

(51) Int. Cl. G06F 16/9535

(52) U.S. Cl. CPC G06F 16/9535

(57) ABSTRACT

An artificial intelligence (AI) assisted business intelligence (BI) reporting system comprises a prompt generation engine configured for receiving a request for information, the request originating from a user of an enterprise, deriving a persona of the user using a setting stored in the internal storage, determining a type of the request based on a rule, retrieving a formatted structure from a template store based on the type of request, updating the formatted structure with enterprise data, finding relevant information from the updated formatted structure using retrieval-augmented generation and semantic search, and processing the relevant information to generate a sample prompt for a large language model (LLM). The LLM output can be refined by a BOT service and visualized for presentation on a user device instantaneous to the receipt of the request for information, eliminating the need for complex BI layers.

### TECHNICAL FIELD

This disclosure relates generally to computer-implemented business intelligence (BI) reporting. More particularly, this disclosure relates to systems, methods, and computer program products for streamlined BI reporting of metrics, leveraging a large language model (LLM) and an artificial intelligence (AI) chatbot (BOT) service.

### BACKGROUND OF THE RELATED ART

Today, business intelligence (BI) is a necessity for enterprises. BI generally covers technologies, methodologies, and strategies used by enterprises for data analysis and management of enterprise data so as to gain insights into enterprise-wide operations. Such insights are integral to decision-making within each enterprise which, in turn, provide a quantifiable way to improve a respective enterprise's performance, identify problems or issues therewithin, find new solutions to those problems or address the issues, and so on.

Currently, there are a variety of BI reporting tools that can be used to analyze data and generate BI reports. Unfortunately, the process and technical stack for integrating analytics with BI have traditionally been prohibitively expensive and/or time consuming. From data collection to BI reporting, this process can take months. Even with the right data, to present or visualize the right insights, this process can take a minimum of two weeks. This is because, once the necessary data is collected, delivering customized insights and associated data is not a straightforward task, both technically and in terms of workflow.

For instance, enterprise data are usually securely stored and managed using a multitude of technologies such as database management, authentication/identity management, enterprise asset management, human resource management, enterprise resource management, network security management, etc. Accordingly, multiple technical teams having disparate specialties would typically be involved in obtaining enterprise data, deriving insights from the enterprise data thus obtained, and providing the insights to end users.

In view of the foregoing, there is a need for a technical solution that streamlines the process and technical stack for integrating analytics with BI. The invention disclosed herein can address this need and more.

### SUMMARY OF THE DISCLOSURE

A goal of this disclosure is to provide a computer-implemented solution that aims to revolutionize how BI data is obtained and processed to gain insights and how such insights are presented. This goal is achieved by streamlining the process and technical stack for integrating analytics with BI through an Extract, Transform, Load (ETL) process. As a result, instead of waiting for weeks, if not months, for BI reporting, an end user can interact with a user-friendly chatbot, ask a few questions, and be presented with insightful answers to the questions. The end user does not need to reach out to any technical team and can just identify the data, access the data, ask questions, and get answers almost immediately.

In some embodiments, the computer-implemented solution is implemented in an AI-assisted BI reporting system that includes a new prompt generation engine operable to create prompts for specific data sources. By analyzing structured data, the prompt generation engine generates default or tailored-made prompts at administrative and user levels. The generated prompts can be based entirely on the underlying data structure, ensuring that teams do not need to share sensitive data with external parties.

In some embodiments, the AI-assisted BI reporting system further includes a streamlined data access layer that eliminates the need for complex BI layers.

In some embodiments, the AI-assisted BI reporting system may implement a method for prompt generation which can include setting up a data source (or data sources). This set up process ensures that the desired input data resides either on an enterprise (customer) side or within a service provider's infrastructure. This set up process also structures the input data using specialized methods (which can be defined by the service provider using, for instance, a data model definition).

In some embodiments, the method can further include configuring a chatbot service. This can include defining the purpose, need, and mode of a chatbot and loading all relevant prompt details into a system implementing the method so that the chatbot is ready to serve with the necessary prompts.

In some embodiments, the method can further include personalization. This can include providing provisions for adding personalized instructions at both administrative and user levels.

In some embodiments, the method can further include uploading or utilizing the generated prompts in a repository.

In some embodiments, users can access insights derived from the structured data, including any additional integrations with LLM (if applicable). In embodiments disclosed herein, the LLM operates externally outside of the AI-assisted BI reporting system.

In some embodiments, a prompt generation engine is operable to perform: receiving a request for information, the request originating from a user of an enterprise; deriving a persona of the user using a setting stored in the internal storage; determining a type of the request based on a rule; retrieving a formatted structure from a template store based on the type of request; updating the formatted structure with enterprise data; finding relevant information from the updated formatted structure using retrieval-augmented generation and semantic search; and processing the relevant information to generate a sample prompt for a large language model.

In some embodiments, the setting stored in the internal storage comprises at least a user customization setting, an action, or a bot-level setting. In some embodiments, the deriving the persona of the user can comprise performing a persona-based correction and wherein the persona-based correction relates to a role of the user. In some embodiments, the updating the formatted structure with the enterprise data utilizes an SQL topology. In some embodiments, the prompt generation engine comprises an augmented Data Definition Language (DDL) scripting component, wherein the retrieval-augmented generation and the semantic search are part of the augmented DDL scripting component of the prompt generation engine. In some embodiments, the processing the relevant information comprises performing a series of operations on an output of the augmented DDL scripting component of the prompt generation engine, wherein the series of operations comprises generating the sample prompt for the LLM through sampling prompts from the updated formatted structure.

One embodiment comprises a system comprising a processor and a non-transitory computer-readable storage medium that stores computer instructions translatable by the processor to perform a method substantially as described herein. Another embodiment comprises a computer program product having a non-transitory computer-readable storage medium that stores computer instructions translatable by a processor to perform a method substantially as described herein. Numerous other embodiments are also possible.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions, and/or rearrangements may be made within the scope of the disclosure without departing from the spirit thereof, and the disclosure includes all such substitutions, modifications, additions, and/or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 depicts a diagrammatical representation of an example of a streamlined AI-assisted reporting system according to some embodiments disclosed herein.

FIG. 2 depicts a diagrammatical representation of an example of a streamlined ETL layer according to some embodiments disclosed herein.

FIG. 3 depicts a diagrammatical representation of an example of a BOT layer according to some embodiments disclosed herein.

FIG. 4 depicts a diagrammatical representation of an example of a BI reporting layer according to some embodiments disclosed herein.

FIG. 5 depicts a diagrammatical representation of an example of a prompt generator working in conjunction with a BOT service and a data access module according to some embodiments disclosed herein.

FIG. 6 depicts a diagrammatic representation of an example of distributed network computing environment where embodiments disclosed herein can be implemented.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

As alluded to above, embodiments disclosed herein take a new approach to processing enterprise data to gain insights. This new BI reporting approach, which can be viewed from multiple aspects, includes streamlining the process and technical stack for integrating analytics with BI through an ETL process.

In some embodiments, streamlining the ETL process can include specifying a source and a destination for data extraction, transformation, and loading and setting data parameters. To facilitate this process, at the front end, a user (e.g., an administrator) is provided with a user-friendly interface that allows the user to identify and/or select data stored in various locations, for instance, in a comma-separated values (CSV) file, in a cloud, in a database, etc.

This can include determining whether to use an entire list of tables and columns or a subset thereof. Next, customer experience is customized. This can include considering factors like access control (e.g., whether any masking is required) and tone. Finally, streamlining an ETL process can leverage a chatbot service to ensure that end users receive their tailored insights via web browsers or embedded applications, for example, through visualizations, summaries, or concise text presented through the web browsers or embedded applications.

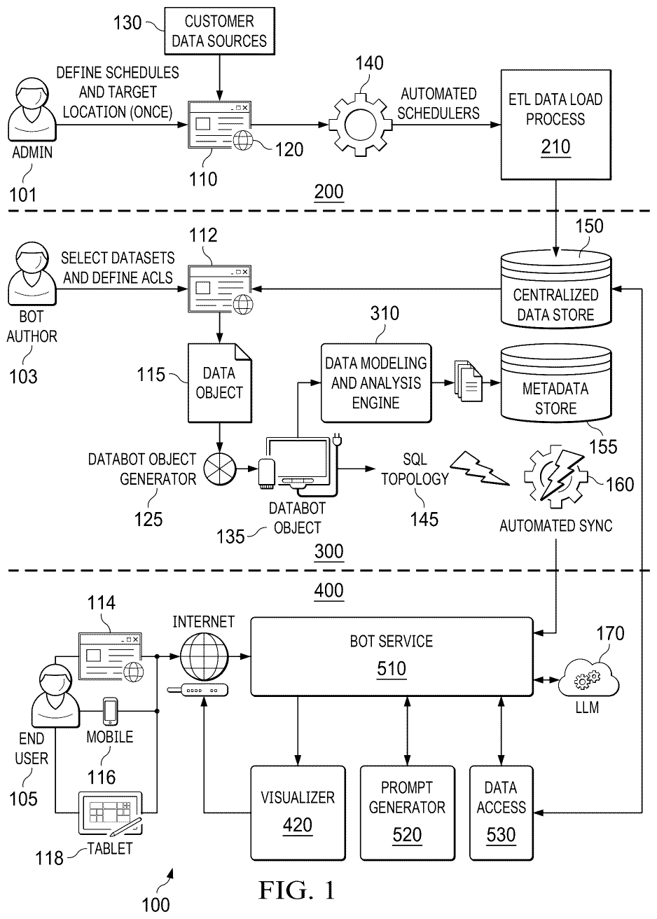

To illustrate these aspects, FIG. 1 depicts a diagrammatical representation of an example of a streamlined AI-assisted reporting system 100 operating in a distributed network computing environment. In the example of FIG. 1, the streamlined AI-assisted reporting system 100 can include an ETL layer 200, a BOT layer 300, and a BI reporting layer 400.

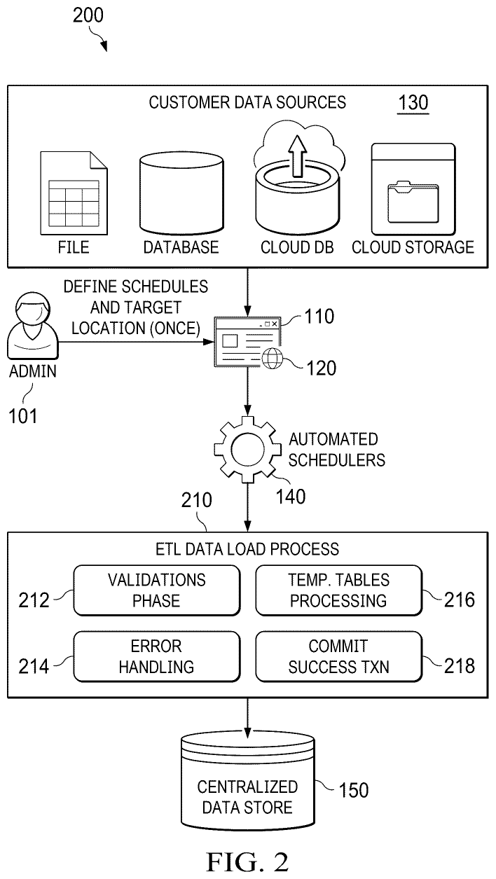

In some embodiments, through the ETL layer 200, an administrator 101 can import data to a centralized data store 150. In some embodiments, through the BOT layer 300, a BOT author 103 can determine data boundaries and define access rules (e.g., access control lists (ACLs)). In some embodiments, through the BI reporting layer 400, an end user 105 can access data and gain insights instantly through user interfaces on various types of user devices (e.g., user devices 114, 116, 118). These aspects are further described below with reference to FIGS. 2-5.

### ETL Layer to BI Reports

Referring to FIG. 2, which depicts a diagrammatical representation of an example of a streamlined ETL layer 200 according to some embodiments disclosed herein, the administrator 101 can log into a management console 110 to define and schedule how customer data (e.g., enterprise content owned by an enterprise customer) is to be imported or otherwise obtained from data source(s) 130 and processed for storage in the centralized data store 150. Examples of data sources 130 can include a file (e.g., a CSV file, a database table, a cloud-hosted database, a data store hosted in a cloud, etc. The administrator 101 may only need to define each target location/data source once.

As a non-limiting example, the management console 110 can be implemented as a web-based interface that runs in an environment provided by a browser 120. The management console 110 is operable to receive a user-provided scheduling instruction and cause automated schedulers 140 to run an ETL data load process 210 in accordance with the user-provided scheduling instruction.

In some embodiments, the ETL data load process 210 can include a plurality of data processing operations, including a validations phase 212, an error handling process 214, template tables processing 216, and commit success 218. As further described below, outputs from the ETL data load process 210 are stored in tables in the centralized data store 150 for use at the BOT layer 300 (e.g., by the bot author 103) and the BI reporting layer 400 (e.g., by a data access module 530).

Streamlining ETL Pipeline with BOT Service

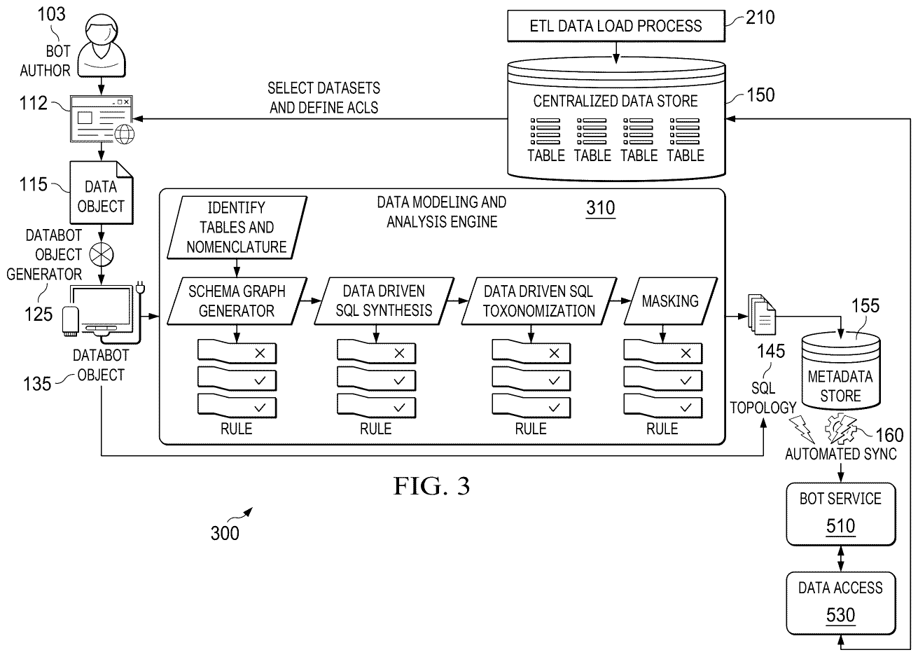

FIG. 3, which depicts a diagrammatical representation of an example of a BOT layer 300 according to some embodiments disclosed herein, illustrates an example of how an ETL pipeline (which includes the ETL data load process 210 at the ETL layer 200 and the use of the centralized data store 150 at the BOT layer 300 and at the BI reporting layer 400) can be streamlined with a BOT service. In this example, the BOT author 103 is provided with a user interface 112 for selecting datasets from the tables stored in the centralized data store 150 and for defining ACLs applicable to the datasets thus selected. As a non-limiting example, the user interface 112 can be configured for allowing the BOT author 103 to define boundaries of the datasets in a view clicks.

In some embodiments, the selected datasets are provided as inputs (e.g., data objects 115) to a databot object generator 125 which, in turn, transforms the data objects 115 into databot objects 135 that can be processed by a data modeling and analysis engine 310. Those skilled in the art will appreciate that this kind of data transformation can vary from implementation to implementation, depending on the type(s) of data stored in the centralized data store 150 and the type(s) of inputs supported by the data modeling and analysis engine 310.

As a non-limiting example, the data modeling and analysis engine 310 is operable to perform a variety of operations on the databot objects 135. These operations can include identifying tables and nomenclature in the databot objects 135 and, based on applicable rules, generating a schema graph, synthesizing SQL statements, creating an SQL taxonomy (i.e., SQL taxonomization), and masking (e.g., masking important/sensitive data for security/privacy reasons). Through this rule-based, data-driven sequential processing, the data modeling and analysis engine 310 gains knowledge on how the datasets, which can be stored in various tables in the centralized data store 150, are linked to each other.

The data modeling and analysis engine 310 then outputs an SQL topology 145 that models/describes the relationships thus discovered among the datasets. In some embodiments, an SQL topology can be implemented as a database schema that describes how data is stored in tables and how tables relate to each other. Below is a non-limiting example of an SQL topology.

bot properties:
{″generalProperties″:{″path″:″/Resources/...″,″autoGenerateSuggestion″:true,″appearance″:{″pan
elTheme″:″,″logo″:″data:image/png;base64,...″,″colorPalette″:″...″},″Hint″:″Ask a
question″,″name″:″HR Avi″,″message″:″Hi! I'm Avi. How can I help you today?\nHere are some
suggested topics based on the provided data. Choose a suggestion below or ask a
question.″,″noOfSuggestions″:3}}
- - - - - - - - - - - -
id
bot_id
bot_properties
created_at
modified_at
{″persona″: ″″}
[timestamp]
============================================
DDLs:
id
embedding
document
bot_id
[...]
CREATE TABLE public.DATA9e45b88a_2b2b_4a94_ab7e_99716c24edf1 ( DistanceFromHome
int, OverTime varchar(4096), BusinessTravel varchar(4096), ...);
============================================
documentations:
id
embedding
document
bot_id
[attrition table]
============================================
SQL pairs:
id
embedding
question
sql
bot_id
artifact_id
[...]
What are the job titles and corresponding salaries of employees who have ′Yes′ as their attrition
status?
SELECT T2.job_title AS ″Job Title″, T2.salary_in_usd AS ″Salary in USD″ FROM
public.DATA9e45b88a... AS T1 JOIN public.DATA338471e3... AS T2 ON T1.EmployeeNumber
= T2.employee_number WHERE T1.Attrition = ′Yes′
=================================
ACL rules:
id
bot_id
aclrules
aclrulesfromllm
created_at
modified_at
=================================

As further described below, the SQL topology 145 can be a source of answers to questions from end users.

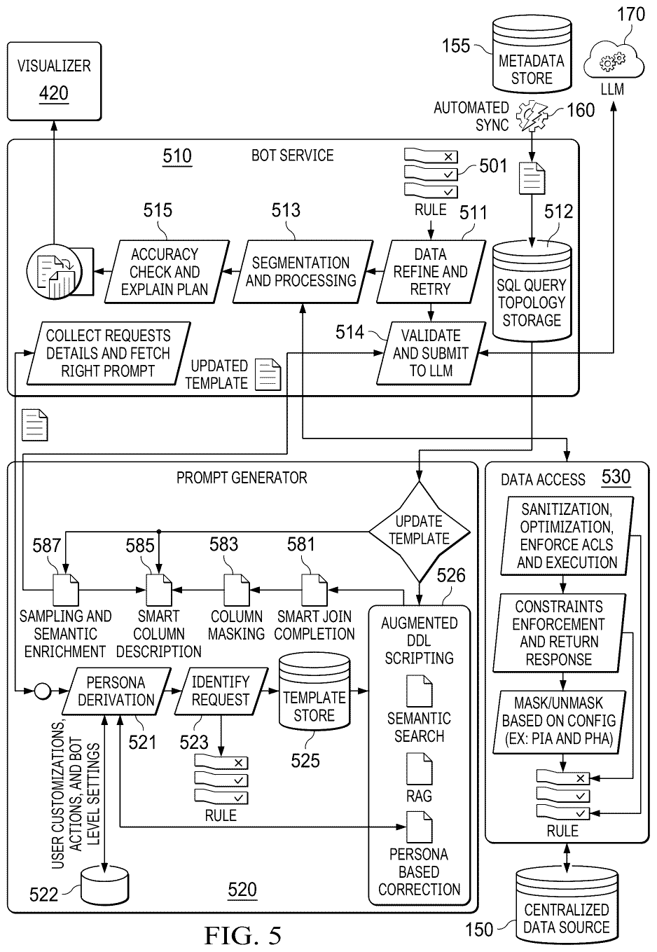

In some embodiments, the SQL topology 145 is stored in a metadata store 155 and automatically synced (e.g., via an automated syncing operation 160) to an SQL query topology storage. As illustrated in FIG. 5, the SQL query topology storage is used by a BOT service 510 at the BI reporting layer 400.

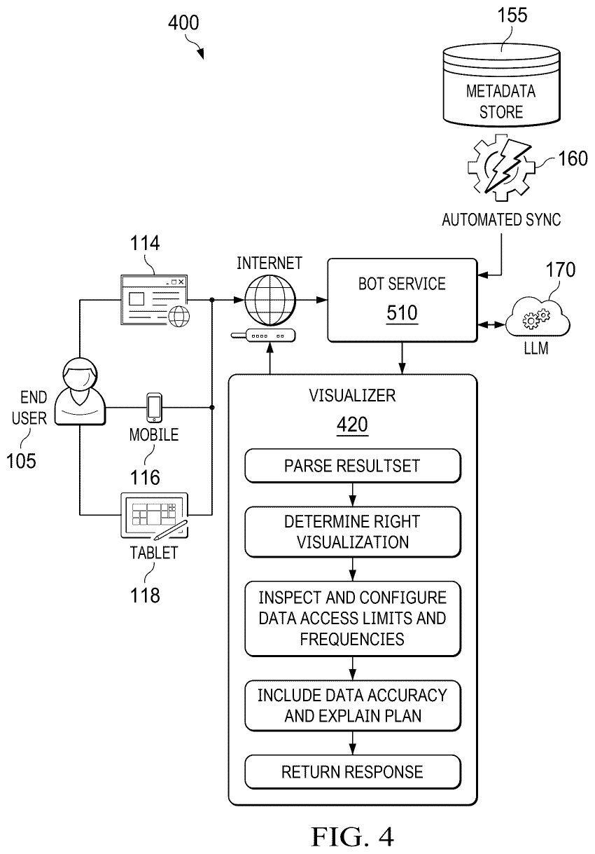

FIG. 4 depicts a diagrammatical representation of an example of a BI reporting layer 400 according to some embodiments disclosed herein. In this example, an end user 105 is provided with an AI-assisted user interface (which can run on a variety of user devices such as a computer 114, a mobile device 116, a tablet 118, etc.). The AI-assisted user interface is implemented with an AI chatbot (e.g., the BOT service 510) provided by an embodiment of the system 100 described above.

As illustrated in FIGS. 1, 3-4, the BOT service 510 has access to the SQL topology 145 generated by the data modeling and analysis engine 310. Further, as illustrated in FIGS. 1 and 4, the BOT service 510 leverages a LLM 170 in interacting with the end user 105. Through the AI-assisted user interface, the end user 105 can ask a BOT (e.g., an avatar of the BOT service 510) some questions about a topic concerning the enterprise data. The BOT service 510 is operable to obtain answers from the enterprise data utilizing the SQL topology 145. Through the SQL topology 145, the BOT service 510 can find an answer (or answers) to a question in a table (or tables) stored in the centralized data store 150 and convert the questions and answers into reportable insights utilizing the LLM 170 and the visualizer 420.

In some embodiments, the visualizer 420 is operable to parse a result set returned by the LLM 170 and determine a visualization appropriate for presenting the result set on a user device (e.g., a user device 114, 116, or 118). The visualizer 420 may further inspect and configure data access limits and/or frequencies based on the permission right(s) of the end user 105. As illustrated in FIG. 5, the visualizer 420 may check data accuracy and supplement the result set with an explanation of what is contained in the result set before returning a response to the end user 105 for display via the AI-assisted user interface on the user device 114, 116, and/or 118.

### Prompt Generation Engine for Structure Data

In some embodiments, a new framework for generating prompts from data sources leverages a new prompt generation engine (which is also referred to herein as a “prompt generator”) 520. FIG. 5 depicts a diagrammatical representation of an example of a prompt generator 520 working in conjunction with the BOT service 510 and the data access module 530 according to some embodiments disclosed herein.

As discussed above with reference to FIG. 4, the AI-assisted user interface leverages the BOT service 510 to collect, for instance, from the end user 105 via a chat channel, details of what is requested by the end user 105 (e.g., “What is the average credit limit of customers in each country?”). As illustrated in FIG. 5, the BOT service 510 utilizes the prompt generator 520 to generate an appropriate prompt (or prompts) back to the end user 105 correspondingly.

Previously, a chatbot may utilize an LLM to respond to a question. However, in an enterprise setting, utilizing an LLM requires bringing the LLM into an enterprise computing environment, training the LLM with the enterprise data, and training the employees in how to use the LLM, as well as setting up the context and the behaviors for the LLM before a question can be asked. Another prior option is to use an LLM in a public setting (i.e., on the Internet). However, this requires pushing the enterprise data to the Internet and also requires training the LLM and the employees and setting up the context and the behaviors for the LLM before a question can be asked.

These prior approaches are not desired as the context and the behaviors for the LLM may differ based on the type of questions asked. As a result, multiple chatbots would need to be configured, each for a specific topic based on topic-specific metadata (e.g., topic-specific terms).

In some embodiments, the prompt generator 520 serves to decouple the LLM 170 and the BOT service 510, allowing the BOT service to handle various types of questions and the LLM 170 to respond with information that can be used to generate appropriate prompts in response to the questions. This decoupling allows the use of the LLM 170 residing externally to the system 100 and avoids having to share the enterprise data, which is stored in a protected network, with the LLM 170.

As illustrated in FIG. 5, the BOT service 510 is operable to collect information from a question asked by the end user 105 (e.g., “What is the average credit limit of customers in each country?”) and fetch an appropriate response (a prompt) from the prompt generator 520. The prompt generator 520, in turn, can derive a persona from the information provided by the BOT service 510 (521), utilizing user customization, actions, and BOT-level settings stored in an internal storage 522.

This personalization can include determining a role of the end user 105, a topic and/or type of the question asked, etc. A goal here is to set the tone and the persona for the logged in end user 105 in view of the role and applicable settings so that the expected outcome format can be set. Based a rule applicable to the type of question asked, the prompt generator 520 can determine a type of “template” (523) and retrieve an appropriate template from a template store 525.

The template can be a formatted data structure that holds some variable and instructions for the particular type of request, for instance, what other related questions might be asked based on historical data. As a non-limiting example, the template can be a JavaScript Object Notation (JSON) object.

In some embodiments, the prompt generator 520 can update the formatted structure with information from the enterprise data using the SQL topology 145 stored in the SQL query topology storage 512.

In some embodiments, the prompt generator 520 includes an augmented DDL scripting component 526 that is operable to take the updated JSON object as an input (e.g., Users Question, Persona, Bot Details, Selected Meta-data) and outputs a filtered list of tables, columns needed for each table, columns-masking details, DDL statements for filtered tables, sample SQLs for selection mode, possible joins between the tables, etc., by performing a semantic search, retrieval augmented generation (RAG), and persona-based correction so as to generate a sample prompt for the LLM 170. Using the outputs from the augmented DDL scripting component 526, the sample prompt can be further processed through a series of operations (e.g., a smart join operation 581, a column masking operation 583, a smart column description 585, and a sampling and semantic enrichment operation 587) before being validated (e.g., by identifying a plurality of elements such as “projection,” “functions,” “source,” “filters,” “group bys,” “limits and order bys,” and checking whether each element is valid, applied to the correct/valid columns, and/or applied according to some specific rules, if any) and submitted to the LLM 170 by the BOT service 510 (514). The sample prompt is fed to the LLM 170. Almost instantaneously, the BOT service 510 receives an output from the LLM 170.

As a non-limiting example, an LLM output may consist of four blocks of information. Three blocks of information are processed by the BOT service 510, while one block of information is processed by the data access component as described above.

The BOT service 510 may further process the LLM output (e.g., by running a data refinement operation 511, a segmentation and processing operation 513, an accuracy check and explanation operation 515, etc. The BOT service 510 may then send the refined LLM output to the visualizer 420.

As illustrated in FIG. 5, the BOT service 510 has access to an SQL query topology storage 512 which stores the SQL topology 145 generated by the data modeling and analysis engine 310 and which is synced from the metadata store 155 via an automated sync operation 160. Thus, the BOT service 510 can refine the output from the LLM 170 with the enterprise data, using the SQL topology 145, and can segment what has to go to the data access component 530. At the data access component 530, a SQL query is executed on the tables to generate an SQL response with metrics. As a non-limiting example, the accuracy check and explanation operation 515 may check how many metrics are in the response and whether the metrics match the response.

Streamlined Data Access without Complex BI Layers

In some cases, there might be a substantial data source or data model generated through a BI reporting process. Suppose there are a diverse set of roles and users who need to consume this data for various purposes. Instead of creating multiple processes for staging and processing the data, the computer-implemented solution disclosed herein provides a new bot service that intelligently authors and consumes data.

An author or system administrator can define data boundaries. This allows the system administrator to control access and behavior. Alternatively, these decisions can be left to end users based on organizational guidelines. An advantage of this approach is that the same data structure can serve different user roles efficiently. As such, each user can access the information they need directly, without involving a BI Layer.

### Use Case

Suppose an end user asked a question about a trend in sales. The prompt generator may identify the type of question as relating to “sales trend” and retrieves a formatted structure specific to “sales trend.” A non-limiting example of the formatted structure may include six variables: “identify table,” “prepare a join,” “time sensitive information,” “example,” “controls,” “regions” as follows:

{identify table}
table 1, 2, x
{prepare a join}
1 → 2
2 → 3
1 → 2 → 3
{time sensitive information}
FYE: Jan to Dec, July to June, Apr to Mar
{example}
{controls}
Do not show UK info
{regions}
Do not include x region

On the fly, the prompt generator selects these six variables from the formatted structure, calculates information needed by the six variables, and put the calculated information in the formatted structure so as to update the corresponding “template” (which is specific to the type of question asked by the end user about a trend in sales). In turn, the BOT service feds the updated information (which is used as sample inputs) to the LLM, receives an output from the LLM, refines and processes the output, and sends the refined output to the visualizer for presentation to the end user. This entire metric reporting process can occur almost instantaneously. As a result, users no longer need to wait weeks, if not months, to gain insights in order to make informed decisions.

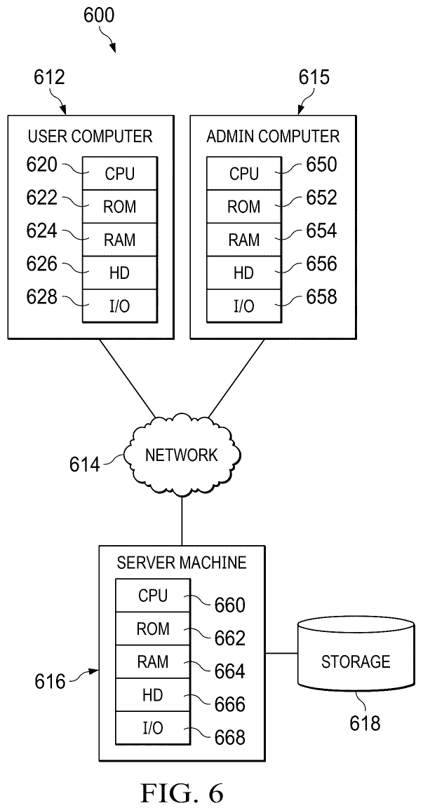

FIG. 6 depicts a diagrammatic representation of an example of distributed network computing environment where embodiments disclosed herein can be implemented. In the example illustrated, network environment 600 includes network 614 that can be bi-directionally coupled to user device 612 (e.g., for a user of an AI-assisted BI reporting system), administrator computer 615 (e.g., for defining schedules and target data location(s) and/or selecting datasets and defining ACLs), and server computer 616 (e.g., for implementing an AI-assisted BI reporting system). Server computer 616 can be bi-directionally coupled to database 618. Database 618 may include a centralized data store configured for storing SQL tables. Network 614 may represent a combination of wired and wireless networks that network computing environment 600 may utilize for various types of network communications known to those skilled in the art.

For the purpose of illustration, a single system is shown for each user device 612, administrator computer 615, and server computer 616. However, within each of user device 612, administrator computer 615, and server computer 616, a plurality of networked devices and computers alike (not shown) may be interconnected to each other over network 614. For example, a plurality of user devices 612, a plurality of server computers 616, and a plurality of administrator computers 615 may be coupled to network 614.

User device 612 can include central processing unit (“CPU”) 620, read-only memory (“ROM”) 622, random access memory (“RAM”) 624, hard drive (“HD”) or storage memory 626, and input/output device(s) (“I/O”) 628. I/O 628 can include a keyboard, monitor, printer, electronic pointing device (e.g., mouse, trackball, stylus, etc.), or the like. User device 612 can include a desktop computer, a laptop computer, a personal digital assistant, a cellular phone, or nearly any network-enabled device capable of communicating over a network. Administrator computer 615 may be similar to user computer 612 and can comprise CPU 650, ROM 652, RAM 654, HD 656, and I/O 658. Likewise, server computer 616 may include CPU 660, ROM 662, RAM 664, HD 666, and I/O 668. Many other alternative configurations are possible and known to skilled artisans.

Each of the computers in FIG. 6 may have more than one CPU, ROM, RAM, HD, I/O, or other hardware components. For the sake of brevity, each computer is illustrated as having one of each of the hardware components, even if more than one is used. Each of computers 612, 615, and 616 is an example of a data processing system. ROM 622, 652, and 662; RAM 624, 654, and 664; HD 626, 656, and 666; and data store 618 can include media that can be read by CPU 620, 650, or 660. Therefore, these types of memories include non-transitory computer-readable storage media. These memories may be internal or external to computers 612, 615, or 616.

Portions of the methods described herein may be implemented in suitable software code that may reside within ROM 622, 652, or 662; RAM 624, 654, or 664; or HD 626, 656, or 666. In addition to those types of memories, the instructions in an embodiment disclosed herein may be contained on a data storage device with a different computer-readable storage medium, such as a hard disk. Alternatively, the instructions may be stored as software code elements on a data storage array, magnetic tape, floppy diskette, optical storage device, or other appropriate data processing system readable medium or storage device.

Those skilled in the relevant art will appreciate that the invention can be implemented or practiced with other computer system configurations, including without limitation multi-processor systems, network devices, mini-computers, mainframe computers, data processors, and the like. The invention can be embodied in a computer or data processor that is specifically programmed, configured, or constructed to perform the functions described in detail herein. The invention can also be employed in distributed computing environments, where tasks or modules are performed by remote processing devices, which are linked through a communications network such as a local area network (LAN), wide area network (WAN), and/or the Internet.

In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory computer-readable medium, hardware circuitry or the like, or any combination and that may be translatable by one or more server machines. Examples of a non-transitory computer-readable medium are provided below in this disclosure.

ROM, RAM, and HD are computer memories for storing computer-executable instructions executable by the CPU or capable of being compiled or interpreted to be executable by the CPU. Suitable computer-executable instructions may reside on a computer-readable medium (e.g., ROM, RAM, and/or HD), hardware circuitry or the like, or any combination thereof. Within this disclosure, the term “computer-readable medium” is not limited to ROM, RAM, and HD and can include any type of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like.

The processes described herein may be implemented in suitable computer-executable instructions that may reside on a computer-readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code any of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more digital computers, by using application specific integrated circuits, programmable logic devices, field programmable gate arrays, optical, chemical, biological, quantum or nanoengineered systems, components and mechanisms may be used. The functions of the invention can be achieved in many ways. For example, distributed or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer-readable medium can be, by way of example only but not by limitation, an electronic, magnetic, optical, electromagnetic, infrared, or semiconductor system, apparatus, system, device, propagation medium, or computer memory. Such computer-readable medium shall be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer-readable media storing computer instructions translatable by one or more processors in a computing environment.

A “processor” includes any hardware system, mechanism or component that processes data, signals or other information. A processor can include a system with a central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein, the meaning of “in” includes “in” and “on” unless the context clearly dictates otherwise.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted. The scope of the invention should be determined by the following claims and their legal equivalents.

1. A system comprising:
a processor;
a computer-readable medium; and
instructions stored on the computer-readable medium and translatable by the processor for implementing a prompt generation engine having an internal storage, wherein the prompt generation engine is operable for:
receiving a request for information, the request originating from a user of an enterprise;
deriving a persona of the user using a setting stored in the internal storage;
determining a subject matter type of the request based on a rule;
retrieving a template from a template store based on the type of request;
updating the template with enterprise data;
obtaining information relevant to the request from the updated template using an augmented Data Definition Language (DDL) scripting component; and
processing the obtained information to generate a prompt for a large language model (LLM).

2. The system of claim 1, wherein the setting stored in the internal storage comprises at least a user customization setting, an action, or a bot-level setting.

3. The system of claim 1, wherein the deriving the persona of the user comprise performing a persona-based correction and wherein the persona-based correction relates to a role of the user.

4. The system of claim 1, wherein the updating the template with the enterprise data utilizes an SQL topology.

5. The system of claim 1, wherein the augmented DDL scripting component utilizes retrieval-augmented generation (RAG) and semantic search.

6. The system of claim 5, wherein the processing the relevant information comprises performing a series of operations on an output of the augmented DDL scripting component and wherein the series of operations comprises generating the prompt for the LLM through sampling prompts from the updated template.

7. The system of claim 6, wherein the LLM operates externally outside of the system.

8. A method for prompt generation, the method comprising:
receiving, by a prompt generator executing on a server machine, a request for information, the request originating from a user of an enterprise;
deriving, by the prompt generator, a persona of the user using a setting stored in the internal storage;
determining, by the prompt generator, a subject matter type of the request based on a rule;
retrieving, by the prompt generator, a template from a template store based on the type of request;
updating, by the prompt generator, the template with enterprise data;
obtaining, by the prompt generator, relevant information relevant to the request from the updated template using an augmented Data Definition Language (DDL) scripting component; and
processing, by the prompt generator, the obtained information to generate a prompt for a large language model (LLM).

9. The method according to claim 8, wherein the setting stored in the internal storage comprises at least a user customization setting, an action, or a bot-level setting.

10. The method according to claim 8, wherein the deriving the persona of the user comprise performing a persona-based correction and wherein the persona-based correction relates to a role of the user.

11. The method according to claim 8, wherein the updating the template with the enterprise data utilizes an SQL topology.

12. The method according to claim 8, wherein the augmented DDL scripting component utilizes retrieval-augmented generation (RAG) and semantic search.

13. The method according to claim 8, wherein the processing the relevant information comprises performing a series of operations on an output of the augmented DDL scripting component and wherein the series of operations comprises generating the sample prompt for the LLM through sampling prompts from the updated template.

14. The method according to claim 13, wherein the LLM operates externally outside of the system.

15. A computer program product comprising a non-transitory computer-readable medium storing instructions translatable by a processor for implementing a prompt generation engine having an internal storage, wherein the instructions when translated by the processor perform:
receiving a request for information, the request originating from a user of an enterprise;
deriving a persona of the user using a setting stored in the internal storage;
determining a subject matter type of the request based on a rule;
retrieving a template from a template store based on the type of request;
updating the template with enterprise data;
obtaining information relevant to the request from the updated template using an augmented Data Definition Language (DDL) scripting component; and
processing the obtained information to generate a prompt for a large language model (LLM).

16. The computer program product of claim 15, wherein the setting stored in the internal storage comprises at least a user customization setting, an action, or a bot-level setting.

17. The computer program product of claim 15, wherein the deriving the persona of the user comprise performing a persona-based correction and wherein the persona-based correction relates to a role of the user.

18. The computer program product of claim 15, wherein the updating the template with the enterprise data utilizes an SQL topology.

19. The computer program product of claim 15, wherein the augmented DDL scripting component utilizes retrieval-augmented generation (RAG) and semantic search.

20. The computer program product of claim 15, wherein the processing the relevant information comprises performing a series of operations on an output of the augmented DDL scripting component and wherein the series of operations comprises generating the prompt for the LLM through sampling prompts from the updated template.
